(19) United States
(12) Patent Application Publication
(10) Pub. No.: US 2017/0260972 A1
(43) Pub. Date: Sep. 14, 2017

(54) Impact Point Energy Conversion Mechanism and Method

(71) Applicant: Robert D. Hunt, Wyndham Bay, MN (US)

(72) Inventor: Robert D. Hunt, Wyndham Bay, MN (US)

(21) Appl. No.: 15/067,177

(22) Filed: Mar. 11, 2016

(51) Int. Cl. F03G 3/00

(52) U.S. Cl. CPC F03G 3/00

(57) ABSTRACT

An apparatus and process for capturing mechanical work from the kinetic energy of a downward moving weighted vessel. The apparatus comprises an elevated downward-moving weighted vessel, a point of impact, a force transfer means to harness the impact, and a post-impact diversion means of the weighted vessel for unobstructed continuation of the process. In use, as the point of impact and force transfer means optimally aligns at the top of their upstroke, the sensor-initiated synchronized release and acceleration of the elevated weighted vessel results in downward movement, generating an exponentially multiplied weight force upon impact due to the accelerated kinetic force it acquires while descending. At the impact point, the kinetic energy force is transmitted from the moving vessel to the energy transfer means. The post-impact weighted moving vessel is then diverted out of the impact area to make way for the unobstructed continuation of the energy transfer cycle.

### BACKGROUND OF THE INVENTION

Public awareness has been increasing regarding environmentally friendly energy sources, also called alternative or renewable energy sources. Most renewable alternative energy sources suffer from poor efficiency and are unable to deliver power in the quantity or potency that would serve as a viable alternate to other traditional energy sources, such as fossil fuels. Renewable alternative energy sources, such as solar panels or windmills, depend on certain environmental conditions for their processes to function properly and lack the potency of power necessary to compete with traditional energy sources in an economical manner. One of the main reasons alternative energy sources cannot compete well with traditional industrial energy sources is that they provide relatively little concentrated power compared to the explosive power produced by combustion-based-fuel energy sources. Although the energy from wind, solar, hydro, gravity, or buoyancy is free, their energy provision is weak when compared to their competition. Their competition is traditional fossil fuels which essentially provide their energy by means of an explosion. Harnessing these explosions makes the per-unit cost of coal, gas, oil, diesel, nuclear, or other non-renewable fuel based energy sources still much more competitive than their “free” competition because they are exponentially more potent. Wind, solar, hydro, gravity and buoyancy are expensive to harness and the output from the best harnessing mechanisms is extremely low compared to the cost of building the mechanism itself, resulting in a poor return on investment and a relatively expensive output of “free” energy. Although the fuel is “free”, the harnessing mechanism is very costly, making the comparative overall cost more. Compared with combustible fuel on the other hand, which neither has free fuel, nor a free harnessing mechanism, the powerful output of energy produced is much greater, making up for the fact that the fuel is not free. One of the most common and enduring of energy sources is the internal combustion engine. This reliable invention has been used for over a century and is well known for being a system capable of providing reliable energy for machinery and electricity. Examples of such systems are shown in U.S. Pat. No. 4,742,801. However, this and other similar systems depend on a costly combustible fuel to provide an amount of explosive force sufficient to drive the system and generate the energy, as taught therein. Still, other inventions that seek to utilize “free” energy such as the weak forces of wind, solar, hydro, gravity or buoyancy, utilize these forces in a way that is weak and unable to compete with the explosive forces of combustion engines. Examples of such systems are shown in Patents and Publication Nos. W02004064221A8, US20100126804A1, and U.S. Pat. Nos. 4,683,720A and 8,516,812B2. The present invention seeks to overcome those limitations by delivering a system and process for providing a similar force as the explosive energy of fossil fuels by utilizing the free impact force produced by kinetic, momentum, and gravitational forces. Velocity exponentially maximizes the force found in gravity alone. When the gravitational force of a weight is combined with momentum and velocity, these forces can exponentially multiply the power given with the force of gravity alone by a multiple of up to several thousands of times, though it is only for a very short period of time upon impact. Such bursts of exponentially multiplied force can be seen in the velocity of a bullet slug exiting a rifle, or a simple 7-ounce hammer used to drive a nail into wood. This invention seeks to exploit the dynamic of kinetic velocity and impact for producing energy, while reducing, or even eliminating, the need for a non-renewable source of fuel.

### BRIEF SUMMARY OF THE INVENTION

The present apparatus and process are capable of delivering useable power or mechanical work by using gravitational and kinetic force to drive an apparatus or means for transferring energy. The main driving forces in the apparatus are the kinetic and gravitational forces of an accelerating descending moving weighted vessel expelled from an elevated position for the purpose of producing a brief moment of explosive impact upon the head of an apparatus or means for converting that energy. After the descent of the moving weighted vessel produces an impact-induced useable energy, the moving weighted vessel diverts out of the impact area to make way for the unobstructed continuation of the energy transfer cycle.

### BRIEF DESCRIPTION OF THE SEVERAL VIEWS OF THE DRAWING

FIG. 1 is a cross section view of a basic embodiment of the apparatus, showing three hypothetically placed weighted vessels 115; one elevated up in the staging area moving toward the sensor triggered release 201 and the downward propulsion accelerator force 207; the second descending and about to impact the head 105 of the energy transfer means, and another that has just finished impact and is fully diverted post-impact. FIG. 2 is an elevation view of only the weighted vessel 115 used to create the impact to the impacted head 105 of the apparatus or means of energy transfer by utilizing its kinetic and potential energy. FIG. 3, 4, 5, 6 and 7 are basic side views of the lower section of the apparatus that show the movement of the weighted moving vessel through its cycle of descent at its various stages throughout the embodiment of the apparatus, each figure being at a stage that is a split-second further along than the previous figure. FIG. 8 is a cross section of one embodiment of the weighted vessel apparatus 115. FIG. 9 is an elevation view of one embodiment of the apparatus, showing one weighted vessel 115 in the waiting area 151, and a second weighted vessel in expulsion position 152 to be expelled and awaiting its sensor triggered release 201 and propulsion accelerated 207 gravity powered descent. FIG. 10 is an alternative version of FIG. 1, with the weight diversion surface 103 being a tipping apparatus and therefore needing a rounded corresponding diversion guiding system 120 which is triggered by the guiding system redirector 211 in a manner conducive to the weight being tipped in order to divert it away from the impacted head. FIG. 11 is another alternative version of FIG. 1, with the weight diversion mechanism being a hinged version of the impact head that collapses immediately after impact as triggered by the diversion surface 103 in order to quickly make way for the recoiling energy transfer means or impacted head 105 as it circles around the reaches its upstroke again. Shortly thereafter, the diversion guiding system 120 re-elevates the weighted vessel 115

### DETAILED DESCRIPTION OF THE INVENTION

With reference to the drawings, the invention will now be described with regard for the best mode and the preferred embodiment. In general, the invention is an apparatus and a process of producing mechanical work and useable energy by recovering and converting kinetic and momentum forces produced by a moving weighted vessel 115 combined with gravitational and other accelerant forces and causing a point of impact which is to be converted into a more convenient energy form. The embodiments disclosed herein are meant for illustration and not limitation of the invention. An ordinary practitioner will understand that it is possible to create many variations of the following embodiments without undue experimentation. The critical driving component of the apparatus and process is the kinetic force generated when an elevated moving weighted vessel 115 descends and causes impact to the impacted head 105 of a driving mechanism 101 which results in energy transfer to a more usable means of harnessing energy that is left undefined in this patent because it can take on many forms such as a crankshaft, turbine, gear, lever, pump, or compression chamber. The force utilized for causing the impact is the force of gravity combined with downward momentum as the moving weighted vessel 115 is dropped or expulsed from an elevated position 152. A downward propulsion accelerator force 207, such as a spring, lever, compression, or other form of force can be utilized as a means to accelerate the descending speed of gravity on the moving weighted vessel, can be used at the beginning of the cycle in conjunction with the sensor triggered release 201 or along the path of the descent of the moving weighted vessel as well. The moving weighted vessel could be made of any weighted material, and in most applications the weight will be some form of dense material such as metal or concrete. The apparatus is capable of driving the head of a mechanism of one or more pistons, levers, pumps, or other energy transferring mechanisms, in a synchronized manner precisely timed with the sensor triggered release 201 of the weighted vessel. After descent and initial impact of the weight 400, all kinetic force is transferred or dissipates and the remaining gravitational force of the weighted vessel continues to drive the impacted head 105 downward toward the bottom of the down stroke 500, gradually diverting by means of a diversion surface 103 the impacting head 111 of the weighted vessel away from the impacted head 105 of the driving mechanism 101 before it reaches the fulcrum of its down stroke 600. The moving weighted vessel moves out of the way of the recoiling impacted head 105 of the driving mechanism so that more subsequent weights can be dropped, continuing the cycle indefinitely. The weight can be re-elevated, restoring its potential energy. The necessary re-elevation method is not specified in this patent and will typically employ buoyancy mechanisms or leveraged lifting mechanisms in order to lift the weights back up to the staging position efficiently, such as the elevation method describe in patent U.S.<buoyancy lifting patent.

It is anticipated that either an expanded network of impact heads, such as a crankshaft with multiple piston heads, will be utilized in order to keep the cycle moving along smoothly, or a large amount of weights are necessary to adequately supply the frequency of needed dropping in order to keep a continuous cycle, such as if only one piston is driving the energy production method.

If a network of impact heads is used, then a re-elevation of the same moving weighted vessel can be employed such as FIG. 11 shows.

A surplus of weights in a waiting area 151 provides a time cushion between the weights being dropped and the weights in transit at the re-elevation area. In this instance, it is preferable that there be one weighted vessel 115 engaged in impact, one weighted vessel waiting in the expulsion position 152 to be expelled, and one or more weights in the waiting area 151 behind the expulsion position 152 weight to rapidly take its place once it is dropped. In addition, there can be a large amount going through the re-elevation process, which likely takes longer than the dropping process depending on the process. The force supplied for the re-elevation process is not specified as a component of this patent but can be any number of elevating methods described in other patents such as <buoyant elevator patent>.

Once the weight is fully re-elevated and has made its way through the waiting area 151 to the expulsion position 152, it is now ready to be released and expelled or propelled downward. That process is as follows: As the piston head transfer or driving mechanism 101 passes by the fulcrum of its down stroke, there is a first timing sensor 205 and second timing sensor 203 which are adjustable sensory mechanisms utilized for the synchronizing of the release trigger 201. The sensory mechanisms can be in the form of several means, such as an electronic sensor or proximity switch or a chain reaction mechanism. There is one, or if needed, multiple timing sensors 205, 203 for the purpose of gauging the speed at which the head transfer or driving mechanism 101 is moving by programmatically measuring the amount of time it takes for the driving mechanism to move from one sensor to the other, which will result in a more synchronized release 201 of the weighted vessel 115 and a maximized impact set into motion as early as at the bottom fulcrum of the down stroke 600. This synchronizing mechanism of two timing sensors 205, 203 triggers the release 201 of the next weight in the expulsion position 152 to be dropped so it will descend down the vertical guiding system 119 and make impact of the weight 400 at the precise time.

Upon impact of the weight 400, the kinetic and potential energy is spent and transfers from the impacting head 111 into the impacted head 105 and through to the driving mechanism 101 such as the piston, lever, or pump. In many applications the driving mechanism 101 will employ some type of flywheel to maintain the momentum for a smooth cycle that is less sporadic.

The cycle can be stopped by not releasing the trigger 201 to drop the weight that is in position to be dropped in the expulsion position 152. Restarting the cycle will typically require different timing adjustments of the trigger release 201 by the two timing sensors 205 203 in order to gradually build up momentum in the overall machinery, depending on the energy transfer apparatus. The overall apparatus will require periodic service and maintenance as required by the particular application and environmental conditions. More frequent maintenance may be required where the system operates in harsh conditions, such as in a desert or in a humid environment.

As a specific example of a moving weight embodiment, the moving weighted vessel 115 comprises a single weight unit made of lead or some other dense material, having a weight of about 2,000 pounds which will drop from an elevation of 20 feet. This particular weighted vessel has wheels 117 fixed to its apparatus that are useful for remaining engaged with the upper guiding system 121, the vertical guiding system 119 and the lower diversion guiding system 120. Its descent will be kept on course by a guiding system, such as a rail, track, lever, or similar vertical guiding system 119. If no accelerants are used and gravity is the only force of descent, the impact of the falling weighted vessel will have a velocity of 23.1 miles per hour upon impact of the weight 400. If the impact point of the impacted head 105 is exactly 20 feet below the sensor triggered release 201. Increasing the elevation of the release will increase the velocity at impact in a reverse inverse-squared ratio. For example, to double the velocity to 46.2 miles per hour, the release point must be four times higher, or 80 feet above the impact.

A 2,000-pound weight hitting a point of impact at 23.1 miles per hour will provide ≈50,000 pounds of total force during the first ˜0.01 seconds of impact, providing an explosive force to drive the head of the piston, lever, pump, or other energy transfer mechanism. When this velocity of added speed is incorporated with the 2000 lb. moving weighted vessel dropped at a height of 20 feet and reaching 23.1 MPH (based on 9.8 m/ŝ2), the resulting force is ≈50,000 pounds for a brief period immediately upon impact of the weight 400 with the impacted head near the top of the up stroke and =2,000 pounds near the bottom of the down stroke 500. The positioning of the impacted head 105 in conjunction with the timing of the elevated weight sensor triggered release 201 will ensure maximized percentage of transferred energy at impact.

Directly following the impact of the weighted vessel 400 there is a sensor 213 that triggers the guiding system redirector 211 which pushes on a hinged mechanism 215 with a rail diverter into place to divert the sub-sequent upper wheel 117 on the weighted vessel 115 down the alternate diversion guiding system 120 in order to assist in diverting the weight away from the point of impact and to allow the current cycle of the driving mechanism to remain unhindered. The concept of the diversion slide or surface 103 and related apparatuses can be duplicated in many variants, such as a tipper, a lever, a pusher, or a diverter. See FIG. 10 and FIG. 11 for examples of alternative variations.

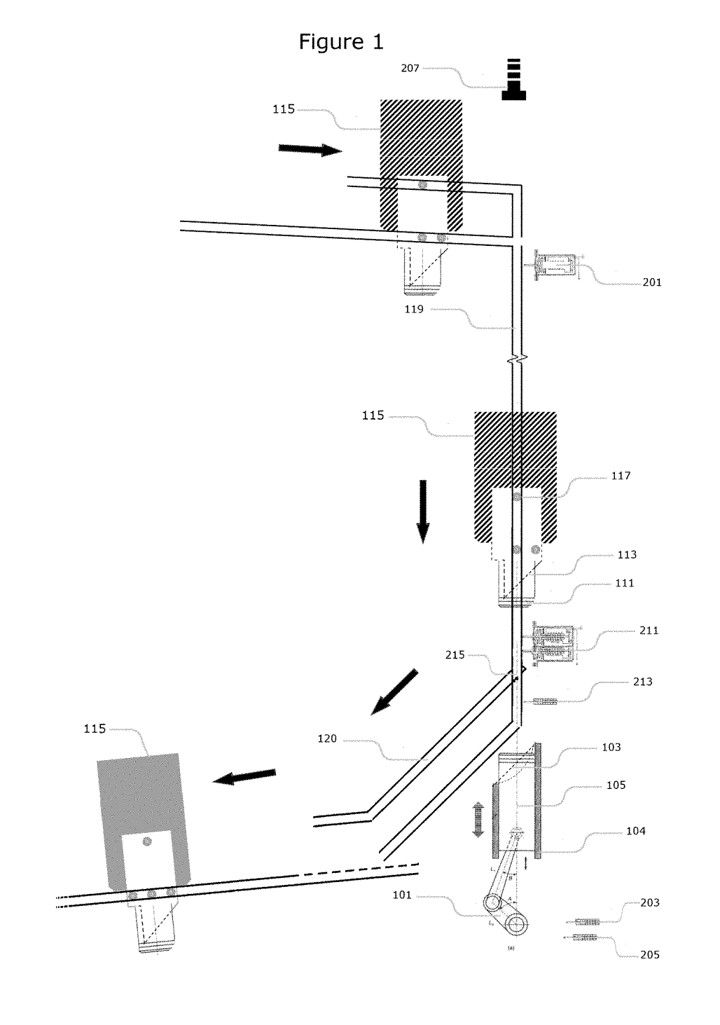

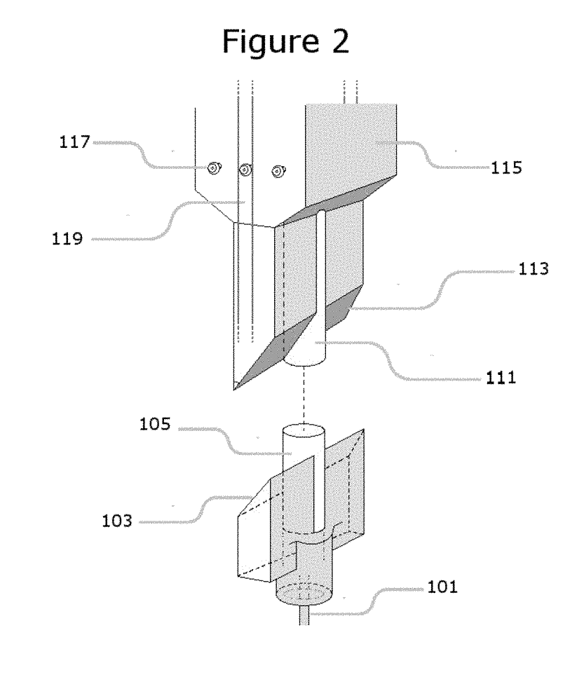

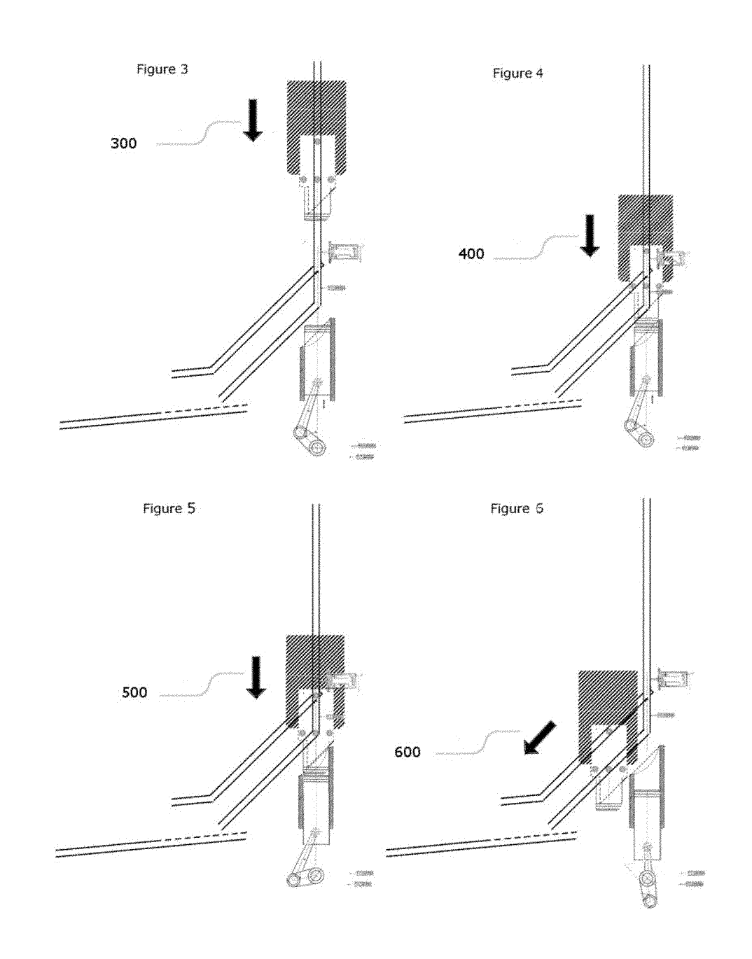

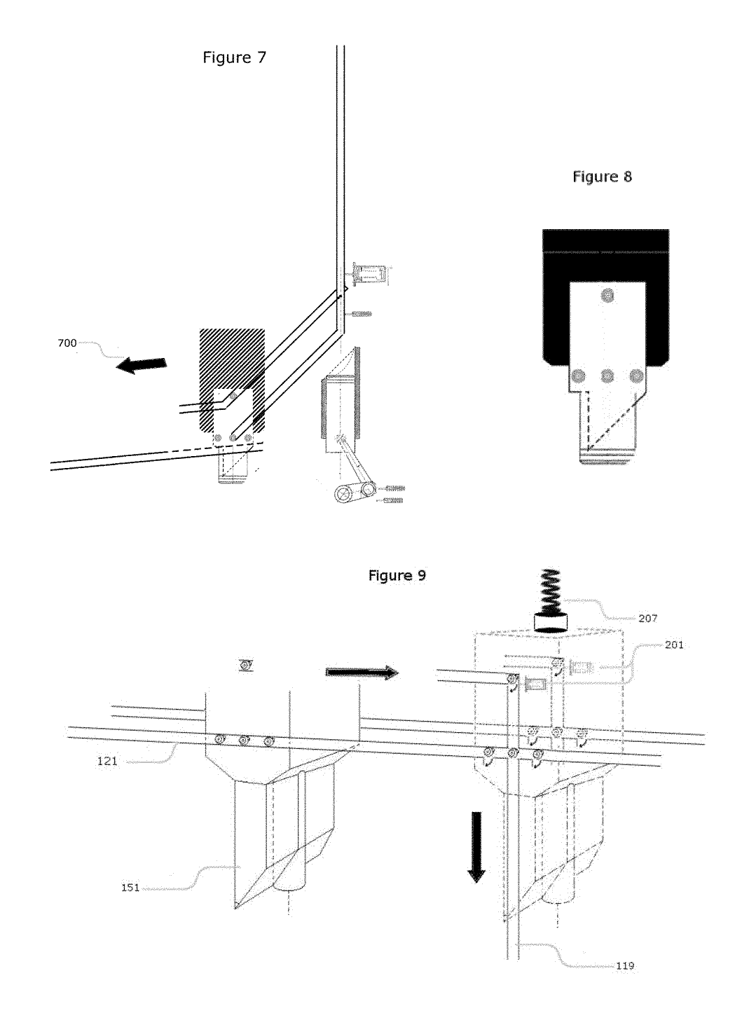

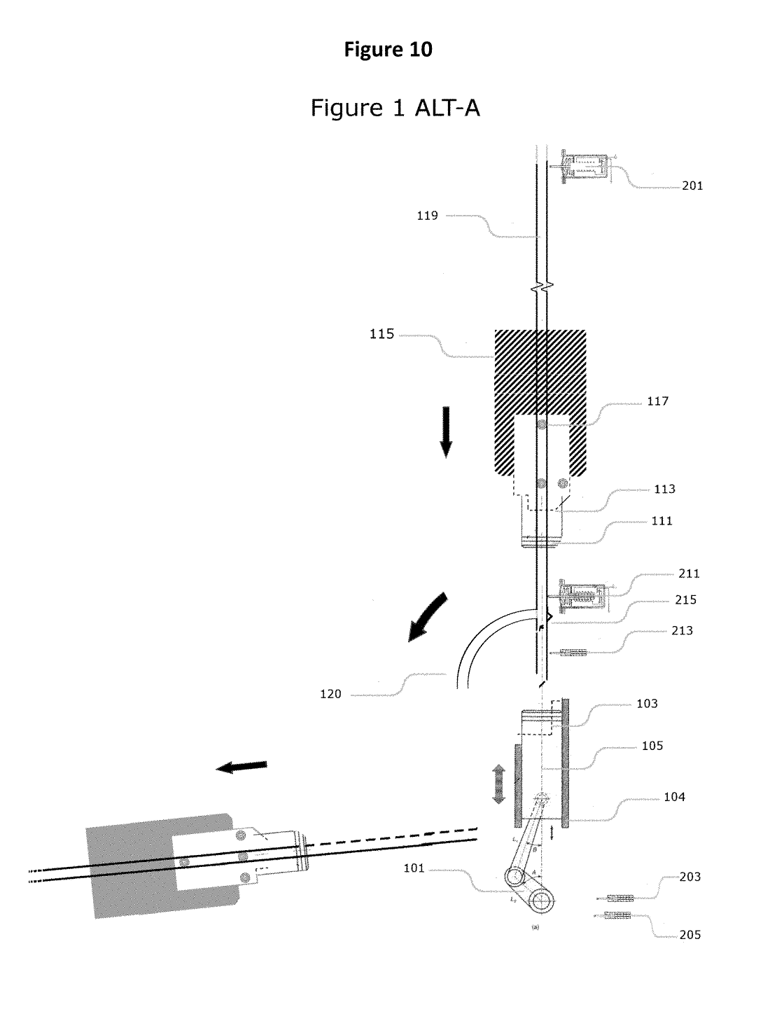

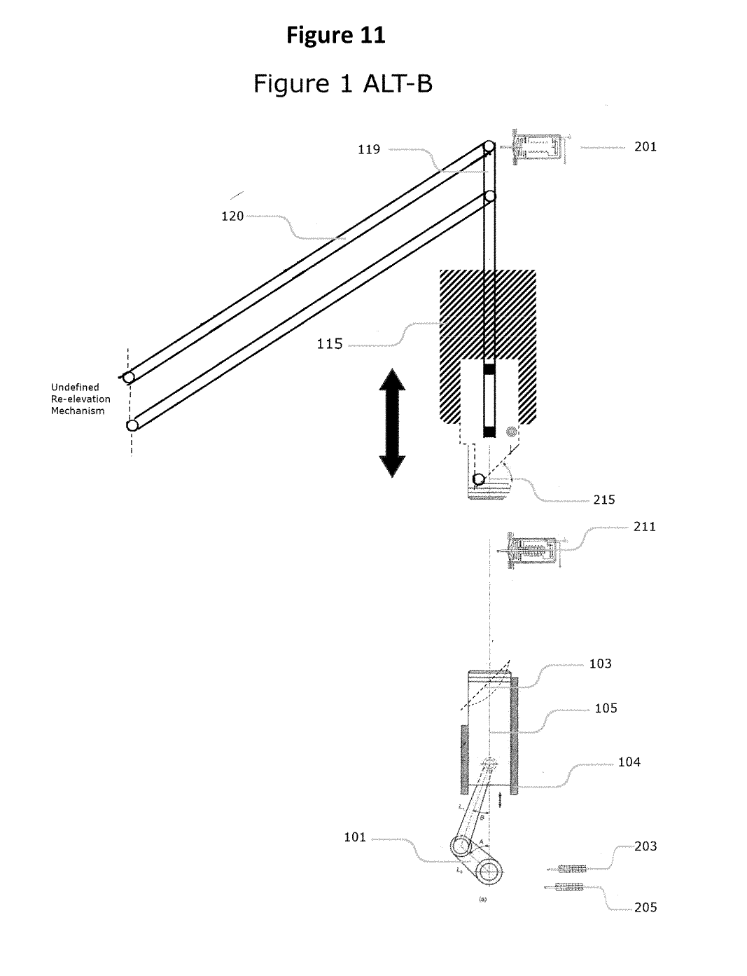

In the piston-type embodiment of the impacted head 105 which serves as the energy transfer means, shown in FIG. 1, the head assembly comprises a piston cylinder which is known as the impacted head 105 having inside walls, a mechanical transfer arm or driving mechanism 101 or other energy transfer means, and a piston head or impacted head 105, which is attached to the moving-arm driving mechanism 101 The moving arm driving mechanism 101 can represent one or more crankshafts, turbines, gears, levers, shafts or pumps and in many applications will have some sort of flywheel or momentum stabilizer. The impacting head 111 is the force transfer producer, transferring the kinetic and gravitational energy to the impacted head 105 upon impact. The impacting head 111 as well as the impacted head 105 are made of a material having a relatively high strength to weight ratio, such as carbon fiber material, steel, or some other type of metal. The piston or pump mechanism incorporates a piston head or impacted head 105, that extends higher than typical pistons that rely on a combustion chamber. The head of the piston rises to a height that extends upward, above the inside wall 104 of the piston cylinder to a height that allows the complete cycle from down stroke to upstroke to take place without the head descending below the top of the piston cylinder walls or diversion surface 103. This allows a sufficient impact area as well as a diversion route to exist for the weight as the piston head descends, allowing the surface area of the impacting head to divert before the piston head reaches the bottom of its down stroke.

In this embodiment, the piston cylinder apparatus further comprises a diverting assistance to the weight, such as the sloped face of a diversion surface 103 or tipping point.

The post-impact diversion method can embody many different setups and configurations for accomplishing the same end result. One method is to divert the weight by utilizing the sloped surface of a diversion surface 103 that uses gravity to divert the weight upon contact with the upper sloped diverting surface 113 adjacent to the weighted vessel's impacting head 111 as well as the lower parallel sloped diversion surface 103. The upper and lower surfaces can utilize rails and rollers or wheels to reduce friction or any other friction reducing agent. The impacting head 111 and the impacted head 105 are arranged with an opposite-facing orientation so as to permit optimum transfer of power upon impact. That is, as the impacting head 111 hits the impacted head 105 and it forcefully moves from the top of the upstroke or the point of impact of the weight 400 down approaching the bottom of the down stroke 500, the impacted head 105 drives the energy means or driving mechanism 101 by way of the explosive kinetic energy contained in the impact of the impacting head 111. Shortly after impact, the diversion surface 103 diverts the weight over to the re-elevation area. The impacted head 105 continues in its momentum to the bottom of its down stroke. Then, when the impacted head 105 moves from the bottom of the piston cylinder, or bottom fulcrum of the down stroke 600 back up approaching the top of its upstroke 700, the two timing sensors 205, 203 signals the sensor triggered release 201 of another weighted vessel from the expulsion area, and the cycle continues.

Another post-impact diversion method can embody a tipping method FIG. 10, where the weight is diverted by utilizing an off-centered elevated point of the diversion surface 103 that interrupts the weight's decent on one side of the weight while the other side continues to fall, creating a tipping effect and diverting the weighted vessel from being obtrusive in the impact area assisted by the diversion guiding system 120.

Yet another post-impact diversion method can embody a hinged lever approach shown in FIG. 11, where the impact head diverts by collapsing a hinged mechanism 215 in the impacting head itself right after impact so it stays out of the way of the impacted head 105 and sent through the diversion guiding system 120 until it can be re-elevated in order to repeat the cycle.

Consequently, it is understood that equivalents and substitutions for certain elements and components set forth above are part of the invention, and therefore the true scope and definition of the invention is to be as set forth in the following claims.

I claim:

1. An apparatus for one or more synchronized mechanisms driven by a combination of gravity, momentum, and potential kinetic energy provided by one or more weighted vessels being expelled downward from an elevation and descending until the weighted vessel causes accelerated impact upon an energy conversion means such as a piston, pump, lever, crankshaft, or similar.

2. The apparatus of claim 1, further comprising a Mechanical or computerized timed release mechanism for a descent that is optimally synchronized with the energy conversion method upon impact based on the timing of its up strokes and down strokes. The timed release mechanism comprises one or more timing sensors that communicate to the sensor-triggered release.

3. The apparatus claim #2 further comprising one or more rails, tracks, lever system, pulley system, or other guiding system for keeping the weighted vessels on-course during its descent, upon impact and during its diversion or re-elevation process.

4. The apparatus of claim #3 further comprising a post-impact weight dissipation or diversion system such as a slope, wheel, tipper,, pusher, puller, collapsible head, or any other means of diverting the impacting head of the weighted vessel off of the impacted head and out of the impact area to make way for the unobstructed continuation of the energy transfer cycle.

5. The apparatus of claim #3 further comprising an apparatus for guiding the weighted vessel to the means of re-elevation post-impact utilizing a system of rails, guides, tracks, levers system, pulley system, or other aiming means that guides the weighted vessels toward subsequent use to continue the energy transfer cycle.

6. The apparatus of claim #4 or #5 further comprising an energy transfer mechanism such as a piston, pump, lever, wheel, or crankshaft.

7. The apparatus of claim #6 further comprising a flywheel or similar apparatus for stabilizing momentum.

8. The apparatus of claim #1, #2, #3, #7 in any combination of one another and either #4 or #5.

9. The apparatus of claim #8 further comprising an apparatus for elevating the weighted vessels so that they can be dropped from that elevation

10. An apparatus for utilizing energy from propulsion and gravitational force and discharged potential energy from kinetic energy force. Said apparatus comprising: a moving weight capable of dropping or being propelled downward in order to increase in gravitational force, and gaining speed such that the falling motion creates a kinetic force in the moving weighted vessel and causing the moving weighted vessel to impact the energy transfer mechanism, which harnesses the explosive force of that impact to drive the energy conversion method, such as a piston, pump, turbine, crankshaft or similar.

11. A method or process for using the impact caused by propulsion, and velocity combined with gravitational, potential energy and kinetic forces to create useable energy, said method comprising the steps of: (a) releasing or expelling downward a weighted vessel at an elevated height; (b) synchronizing the timing of the impact of said weighted vessel on an energy conversion means; (c) guiding and aiming the weighted vessel to keep it on course during its descent and ascent; (d) transferring the energy caused by the impact of the weighted vessel by utilizing an energy conversion means such as a piston, pump, lever, crankshaft, etc.
